(19) United States
(12) Patent Application Publication
(10) Pub. No.: US 2019/0197522 A1
(43) Pub. Date: Jun. 27, 2019

(54) METHODS AND SYSTEMS TO PAY USING UNIQUE STRING

(71) Applicant: MASTERCARD INTERNATIONAL INCORPORATED, Purchase, NY (US)

(72) Inventors: Pooja Tarachand Jangid, Kolhapur (IN); Millan Kaul, Pune (IN)

(21) Appl. No.: 16/209,462

(22) Filed: Dec. 4, 2018

(30) Foreign Application Priority Data
Dec. 22, 2017 (SG) 10201710740R

(51) Int. Cl. G06Q 20/34; G06Q 20/20; G06Q 20/40

(52) U.S. Cl. CPC G06Q 20/351; G06Q 20/204; G06Q 20/4018; G06Q 20/4012; G06Q 20/206

(57) ABSTRACT

Embodiments provide methods, and server systems for facilitating payment transactions using unique strings. In an embodiment, the method includes receiving, by a server system associated with a payment network, a payment transaction request comprising at least a payment string uniquely associated with the payment card linked with the issuer account and a transaction amount to be paid to the merchant. The method includes verifying a validity of the payment string based on at least one rule set. The method includes retrieving issuer account information associated with the issuer account based on at least a part of the payment string upon successful validation of the payment string. The method includes facilitating the payment transaction based at least on the retrieved issuer account information from the issuer account to the acquirer account.

### CROSS-REFERENCE TO RELATED APPLICATION

This application claims the benefit of and priority to Singapore Patent Application No. 10201710740R filed Dec. 22, 2017. The entire disclosure of the above application is incorporated herein by reference.

### FIELD

The present disclosure relates to payment transactions from users to merchants and, more particularly to, performing an alternate payment transaction method using a unique string that can be used even when a physical payment card, cash or mobile phone is not available with the user at the time of making payment transaction.

### BACKGROUND

This section provides background information related to the present disclosure which is not necessarily prior art.

Nowadays, most users use several banking cards, such as credit cards, debit cards, prepaid cards, etc., for performing financial transactions (e.g., payment transaction). The various banking cards are herein referred to as payment cards. The payment cards are increasingly used for making payments at point-of-sale (POS) terminals available at various facilities including, but not limited to, retail establishments (e.g., merchants like McDonald's™ or Walmart™) or businesses (e.g., ticket reservation centers) that handle cash or credit transactions. The payment cards are generally swiped or inserted into a POS terminal present at these facilities for initiating the financial transaction.

In some scenarios, instead of swiping or inserting the payment card into the POS terminal, some users can store the payment cards in digital format in their mobile phones or in payment applications to complete the payment. In other alternate methods, users can typically scan a machine-readable code such as Quick Response (QR) code present at the payment counters using an application installed on their mobile phones. Once the QR code is accepted by the application, the user's payment card account is verified to process the transaction. Alternatively, the users can make online payment transactions using their mobile phones or any other device equipped with internet access, wherein the users need to provide the relevant details such as payment card number, expiry date, Card Verification Value (CVV), one-time password (OTP) details, billing details and the like.

In the above payment transaction methods, the user is required to either carry the physical payment card and/or should have corresponding payment applications present in his mobile phone with adequate internet connectivity to carry out the payment transaction. However, sometimes, the user may not have the payment card with him, or his mobile phone may not be equipped with payment applications or with adequate internet bandwidth, while visiting a merchant facility. In such scenarios, the user may not be able to make payment transactions. Also, keeping the cash, physical payment card and payment card details/applications in the mobile phone may not be safe all the times, and can lead to compromise in the overall personal and financial security. Further, making an online transaction at the online merchant interface requires remembering and inputting a lot of payment card details and billing details by the user, leading to a frustrating experience.

Accordingly, there is a need for techniques that can allow the users to carry out payment transactions at merchant facilities without using the physical payment card, or without need to include a lot of payment card details in the online merchant interface for the completion of the financial transaction.

### SUMMARY

This section provides a general summary of the disclosure, and is not a comprehensive disclosure of its full scope or all of its features. Aspects and embodiments of the disclosure are set out in the accompanying claims.

Various embodiments of the present disclosure provide systems, methods, electronic devices and computer program products to pay using unique string to the merchants.

In an embodiment, a method for facilitating a payment transaction from an issuer account of a user to an acquirer account of a merchant without swiping or entering card details of a payment card at a merchant interface of the merchant is disclosed. The method includes receiving, by a server system associated with a payment network, a payment transaction request. The payment transaction request includes at least a payment string uniquely associated with the payment card linked with the issuer account and a transaction amount to be paid to the merchant. The method includes verifying a validity of the payment string based on at least one rule set. Upon successful validation of the payment string, the method includes retrieving issuer account information associated with the issuer account based on at least a part of the payment string. Furthermore, the method includes facilitating the payment transaction based at least on the retrieved issuer account information from the issuer account to the acquirer account.

In another embodiment, a server system configured to facilitate a payment transaction from an issuer account of a user to an acquirer account of a merchant without swiping or entering card details of a payment card at a merchant interface of the merchant is provided. The server system includes a communication interface configured to receive a payment transaction request comprising at least a payment string uniquely associated with the payment card linked with the issuer account and a transaction amount to be paid to the merchant. The server system further includes at least one processor in operative communication with the communication interface. The at least one processor is configured to verify a validity of the payment string based on at least one rule set. Upon successful validation of the payment string, the at least one processor is further configured to retrieve issuer account information associated with the issuer account based on at least a part of the payment string. The at least one processor is further configured to facilitate the payment transaction based at least on the retrieved issuer account information from the issuer account to the acquirer account.

In yet another embodiment, a server system configured to facilitate a payment transaction from an issuer account of a user to an acquirer account of a merchant without swiping or entering card details of a payment card at a merchant interface of the merchant is provided. The server system includes a database comprising a mapping table. The mapping table is configured to store mapping of a plurality of predefined length alphanumeric codes and a plurality of issuer account information associated with a plurality of users. The server system includes a communication interface configured to receive a payment transaction request comprising at least a payment string uniquely associated with the payment card linked with the issuer account and a transaction amount to be paid to the merchant. The payment string includes a predefined length alphanumeric code of the plurality of predefined length alphanumeric codes. The server system includes a memory comprising executable instructions and a processor communicably coupled to the communication interface and the database. The processor is configured to execute the instructions to cause to the server system to verify a validity of at least the predefined length alphanumeric code of the payment string based on at least one rule set. Upon successful validation of the predefined length alphanumeric code, the server system is further caused to retrieve an issuer account information associated with the issuer account based on matching the predefined length alphanumeric code in the mapping table. The server system is further caused to facilitate the payment transaction based at least on the retrieved issuer account information from the issuer account to the acquirer account.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, for a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIG. 2 illustrates an example representation of a payment string generated for facilitating a payment transaction, in accordance with an example embodiment of the present disclosure;

FIG. 3 represents a sequence flow diagram representing a completion of a payment transaction using a payment string at a POS terminal, in accordance with an example embodiment;

FIG. 4 represents a sequence flow diagram representing a completion of a payment transaction using a payment string at a POS terminal, in accordance with another example embodiment;

FIG. 5 represents a simplified schematic representation depicting a mapping table stored in a payment server for verifying a payment string for a completion of a payment transaction, in accordance with an example embodiment;

FIG. 6 represents a simplified block diagram representation of generation of a Human Generated Password (HGP) by a user, in accordance with an example embodiment;

FIG. 7 illustrates a flow diagram of a method for carrying out payment transaction using payment string, in accordance with an example embodiment;

FIG. 8 is a simplified block diagram of a server system used for payment transaction using payment string, in accordance with one embodiment of the present disclosure;

FIG. 9 is a simplified block diagram of a POS terminal used for payment transaction using payment string, in accordance with one embodiment of the present disclosure;

FIG. 10 is a simplified block diagram of an issuer server for payment transaction using payment string, in accordance with one embodiment of the present disclosure;

FIG. 11 is a simplified block diagram of an acquirer server used for payment transaction using payment string, in accordance with one embodiment of the present disclosure;

FIG. 12 is a simplified block diagram of a payment server used for payment transaction using payment string, in accordance with one embodiment of the present disclosure; and

FIG. 13 shows simplified block diagram of a user device capable of implementing at least some embodiments of the present disclosure.

The drawings referred to in this description are not to be understood as being drawn to scale except if specifically noted, and such drawings are only exemplary in nature.

Corresponding reference numerals indicate corresponding parts throughout the several views of the drawings.

### DETAILED DESCRIPTION

Embodiments will be described, by way of example only, with reference to the drawings. The description and specific examples included herein are intended for purposes of illustration only and are not intended to limit the scope of the present disclosure.

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account”, used throughout the description, refers to a financial account that is used to fund the financial transaction (interchangeably referred to as “payment transaction”). Examples of a payment account include, but are not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data stored in a user device, where the data is associated with payment account such that the data can be used to process the financial transaction between the payment account and a merchant's financial account.

Various example embodiments of the present disclosure provide methods, systems, user devices and computer program products for making payment using unique payment strings in facilities such as supermarkets, restaurants, hotels, ticket counters, e-commerce websites and the like, thereby eliminating the need to carry physical payment cards, cash or the mobile phone for processing the payment transaction.

In various example embodiments, the present disclosure provides a merchant interface that can be used by the user/customer to enter a unique payment string to process a payment transaction. A server system is configured to receive the payment transaction request that includes a payment string associated with a payment card linked with an issuer account of a user and the transaction amount. The server system is configured to verify the payment string based on predefined rule sets. The payment string includes a combination of a user generated password (hereinafter referred to as human generated password (HGP)), a predefined length alphanumeric code (hereinafter referred to as chord) and a personal identification number (PIN) associated with the payment card of the user. The HGP is a three digit long dynamic password configured to change based on a predefined pattern such as based on days of months, days of weeks and the like. The chord (e.g., 404 chord) is six character long alphanumeric code (A-Z, 0-9) unique to the payment card of the user. The PIN is a four-digit number and may be verified by the server system. All three parts of the unique string can be bundled together, and it can be parsed by one or more server systems to extract relevant information such as issuer account information for effecting payment transaction from the issuer account to the acquirer account.

In one embodiment, the user enters the unique payment string at the POS terminal or any other merchant interface such as online merchant interface, the POS terminal (or the online merchant interface) sends a payment transaction request to an acquirer server (an example of the server system) associated with an acquirer bank of the merchant. The payment transaction request comprises the payment string and the transaction amount, among other data. The acquirer server sends the payment string along with other payment details such as transaction amount to an interchange server (i.e., a payment server, an example of the server system). The payment server checks for the validity of the format of the unique payment string, and parses the payment string to extract the issuer account information of the user. More specifically, the payment server extracts the alphanumeric part i.e., the chord of the payment string, and retrieves the issuer account information associated with the issuer account from a mapping table accessible to the payment server.

Once, the payment server has the issuer account details, the payment server sends the HGP, transaction amount and the issuer account information to an issuer server (an example of the server system) associated with an issuer bank of the user. The issuer server verifies the HGP (and optionally PIN) of the payment string and processes the payment transaction. It is noted that verifying the HGP at the issuer server acts as an added layer of security for the payment transaction. In some embodiments, the issuer server can verify the PIN that is a part of the string before realizing the payment from the issuer account to the acquirer account. Alternatively, the PIN can also be verified at the payment server, and the payment server only provides the HGP part of the payment string and the issuer account information to the issuer server. Once the HGP part and the PIN are verified, the payment transaction is completed from the issuer account to the acquirer account.

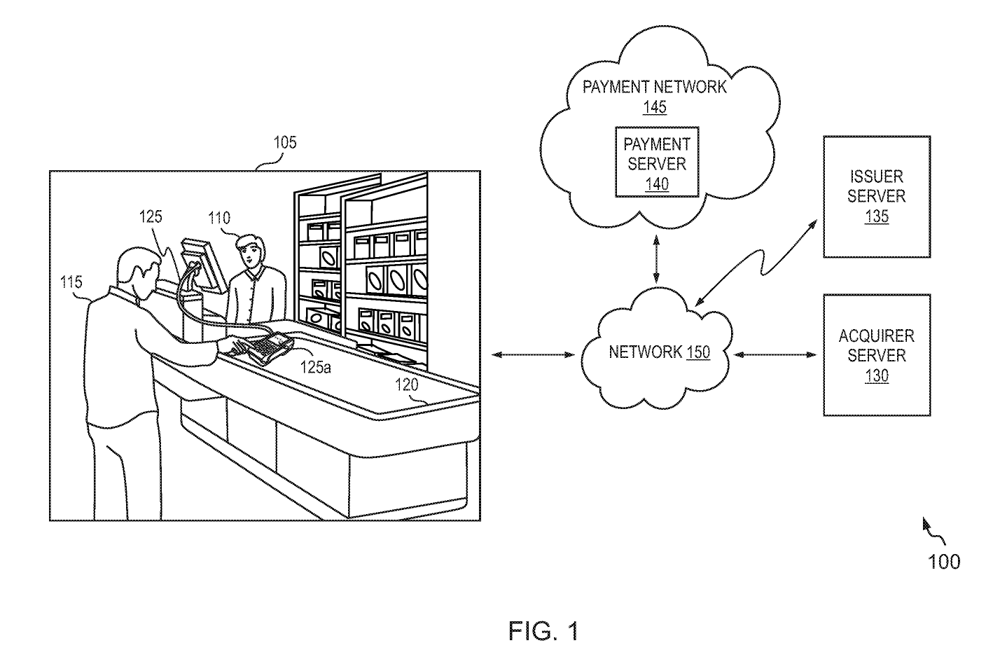

FIG. 1 illustrates an example representation of an environment 100, in which at least some example embodiments of the present disclosure can be implemented. In the illustrated embodiment, a facility 105 is shown. Examples of the facility 105 may include any retail shop, supermarket or establishment, government and/or private agencies, ticket counters, or any such place or establishment where users visit for performing financial transaction in exchange of any goods and/or services or any transaction that requires financial transaction between the user and the facility 105.

As can be seen from the environment 100, a customer 115 (hereinafter referred to as user 115) is standing near a payment desk 120 to make the financial transaction to a merchant 110 for a product purchased by the user 115 from the facility 105. The facility 105 also includes a merchant interface 125. Examples of the merchant interface 125 include a point of sale device or a point of sale terminal 125 (hereinafter interchangeably referred to as ‘POS terminal 125’) placed on the payment desk 120 where the payment transaction can be initiated. In various embodiments, the merchant interface 125 can be a merchant telephone, merchant computer system. Alternatively or additionally, the merchant interface 125 can also be an online merchant interface such as a merchant website, mobile or desktop applications, or third party websites or applications using which the user 115 may purchase goods or service from a remote location or with in-store presence.

Various embodiments of the present disclosure provide mechanisms such that the user 115 is only required to enter a payment string (such as the payment string 125a) at the merchant interface such as the POS terminal 125 instead of carrying the physical payment cards to the facility 105 and swiping the payment card at the POS terminal 125. Accordingly, the user 115 needs to spend relatively less time at the POS terminal 125 for completing the payment transaction, which leads to reduction in overall time required for completing the payment transaction. As shown in the environment 100, the user 115 is entering a unique payment string 125a (exemplarily depicted as **** . . . ) (hereinafter alternatively referred to as string 125a) using the POS terminal 125. Alternatively, in the embodiment of the merchant interface being the online merchant interface, the user 115 may use his mobile phone or any other electronic device while purchasing a product online from the merchant website using the internet and be requested to enter the string 125a to initiate the payment transaction.

In a non-limiting example, verification of the string 125a and authentication of the user's bank account with sufficient funds for making a transaction of ‘X’ amount to complete the payment transaction is performed by a combination of an issuer server 135, an acquirer server 130 and a payment server 140. In one embodiment, the payment server 140 is associated with a payment network 145. The payment network 145 may be used by payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.).

The issuer server 135 is associated with a financial institution normally called an “issuer bank” or “issuing bank” or simply “issuer”, in which the user 115 may have an account, which issues a payment card, such as a credit card or a debit card. The issuer server 135 also facilitates unique string based electronic payment transaction facility to the user 115, described in various embodiments of the present disclosure. The unique payment strings (i.e., the string 125a) are linked to payment cards associated with the user 115. The user 115, being the cardholder, can use any of the payment strings associated with the payment cards to tender payment for a purchase from the merchant 110.

To accept payment using the payment string based electronic payment transaction, the merchant 110 must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank.

Using the payment network 145, the computers of the acquirer/the acquirer server 130 or the merchant processor will communicate with the computers of the issuer/the issuer server 135 to determine whether the user's account is in good standing and whether the purchase is covered by the user's available account balance. Based on these determinations, authorization of the payment transaction is declined or accepted. When the authorization is accepted, the available balance of user's account 112 is decreased. Normally, a charge is not posted immediately to a user's account because bankcard associations, such as Mastercard International Incorporated®, have promulgated rules that do not allow a merchant to charge, or “capture,” a transaction until goods are shipped or services are delivered. When the merchant 110 ships or delivers the goods or services, the merchant 110 captures the transaction by, for example, appropriate data entry procedures on the POS terminal 125. If the user 115 cancels a transaction before it is captured, a “void” is generated. If the user 115 returns goods after the transaction has been captured, a “credit” is generated.

After a transaction is captured, the transaction is settled between the merchant 110, the acquirer and the issuer. Settlement refers to the transfer of financial data or funds between the merchant's account, the acquirer, and the issuer, related to the transaction. Usually, transactions are captured and accumulated into a “batch”, which is settled as a group.

A user device (e.g., a mobile phone or desktop computer of the user 115), the merchant device (e.g., the POS terminal 125) associated with the merchant interface, the issuer server 135, the acquirer server 130 and the payment server 140 communicate with one another using a network 150. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, personal communication services (“PCS”), infrared communications, global area networks, or other suitable networks, etc., or any combination of two or more such networks.

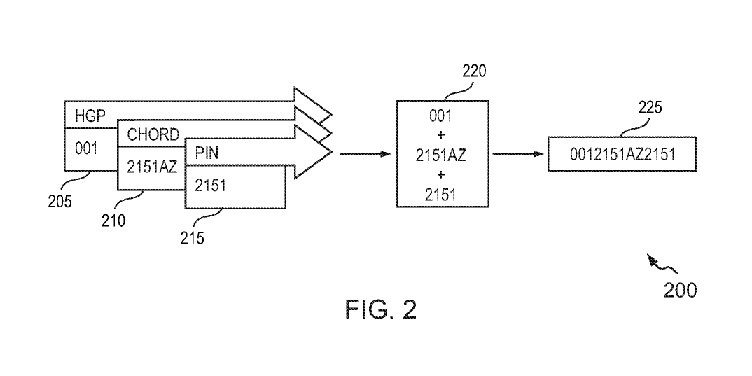

Since the user 115 is needed to only enter the payment string 125a for making a payment to the merchant 110, the overall transaction flow is effortless for completing the payment transaction. In existing payment transaction methods (i.e., not in accordance with the present disclosure), the user 115 is required to carry his physical payment card for purchasing an item from the merchant 110, so that the user 115 can swipe the payment card into the POS terminal 125, or user 115 is required to enter details such as payment card number, date of expiry, CVV details, etc., in case of online transaction. In contrast to existing payment transaction methods, by using the embodiments of the present disclosure, the user 115 is only required to enter the string 125a in the POS terminal 125 or on the online merchant interface, to process the payment transaction. Hence, the user 115 needs not to worry about keeping the payment cards with him so that theft related issues get eliminated in addition to faster transaction time, using various techniques of the present disclosure. Some non-exhaustive example embodiments of completing payment transactions using payment strings are described with reference to the following description, particularly with reference to FIGS. 2 to 6.

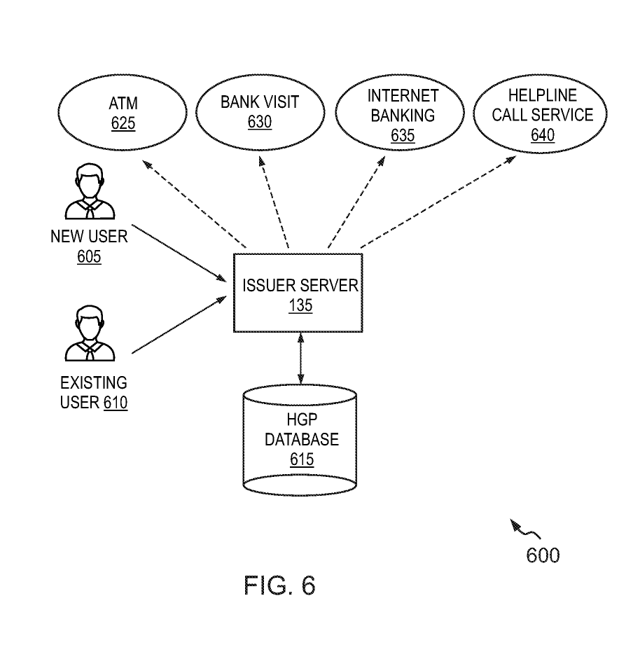

FIG. 2 illustrates an example representation 200 of a payment string 225 generated for facilitating a payment transaction, in accordance with an example embodiment of the present disclosure. As shown, the payment string 225 (hereinafter alternatively referred to as string 225) is exemplarily depicted as ‘0012151AZ2151’. The string 225 is an example of the string 125a as entered by the user 115 of FIG. 1 at the facility 105. In one embodiment, the string 225 comprises 3 unique parts, for example, a human generated password (HGP) 205 (see, 001), a chord 210 (see, 2151AZ) and a personal identification number (PIN) 215 (see, 2151). In an example embodiment, the HGP 205 is runtime generated dynamic password. The HGP 205 can be a predefined code based on a particular pattern, where the pattern can be set by a user (such as the user 115) by accessing an interface provided by the issuer sever 135. In one embodiment, an HGP generation is facilitated by the issuer server 135 associated with the issuer bank of the user in which the user holds a payment account. Generation of the HGP is explained later with reference to FIG. 6.

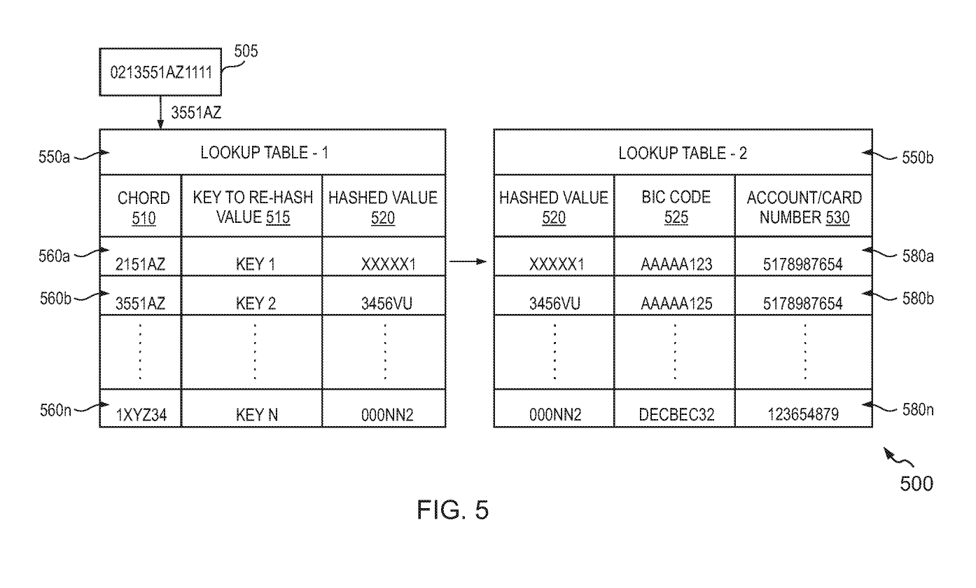

The chord 210 is a six character long alpha-numeric chord that is uniquely generated for the payment card of user for completion of payment transaction using the string 225. In one embodiment, the chord 210 is generated by the payment server 140 associated with the payment network 145. The payment server 140 is configured to store the unique chord associated with each user in a mapping table. The mapping table further includes issuer account information of the user's payment card, where the issuer account information is mapped to the unique chord. The issuer account information is retrieved from the mapping table, when the string 225 is received by the payment server 140. The mapping table is explained in detail with reference to FIG. 5 later.

The PIN 215 is a four-digit identification code issued by the issuer bank of the user while registering for electronic payment transactions or while issuing the payment card to the user. For example, the PIN 215 may be issued for swipe based transactions, mobile banking, internet banking, payment string based transaction and the like. The PIN 215 is needed to be verified for authentication of the user's identity and association with the issuer bank to process the payment transaction. In an example embodiment, the payment server 140 is configured to verify the PIN 215. Alternatively or additionally, the issuer server 135 is configured to verify the PIN 215. As shown by a box 220, all the three parts such as the HGP 205, the chord 210 and the PIN 215 are combined/bundled together to form the unique payment string 225. The verification of the payment string 225 is performed by a combination of servers such as the payment server 140 and the issuer server 135, and is explained hereinafter.

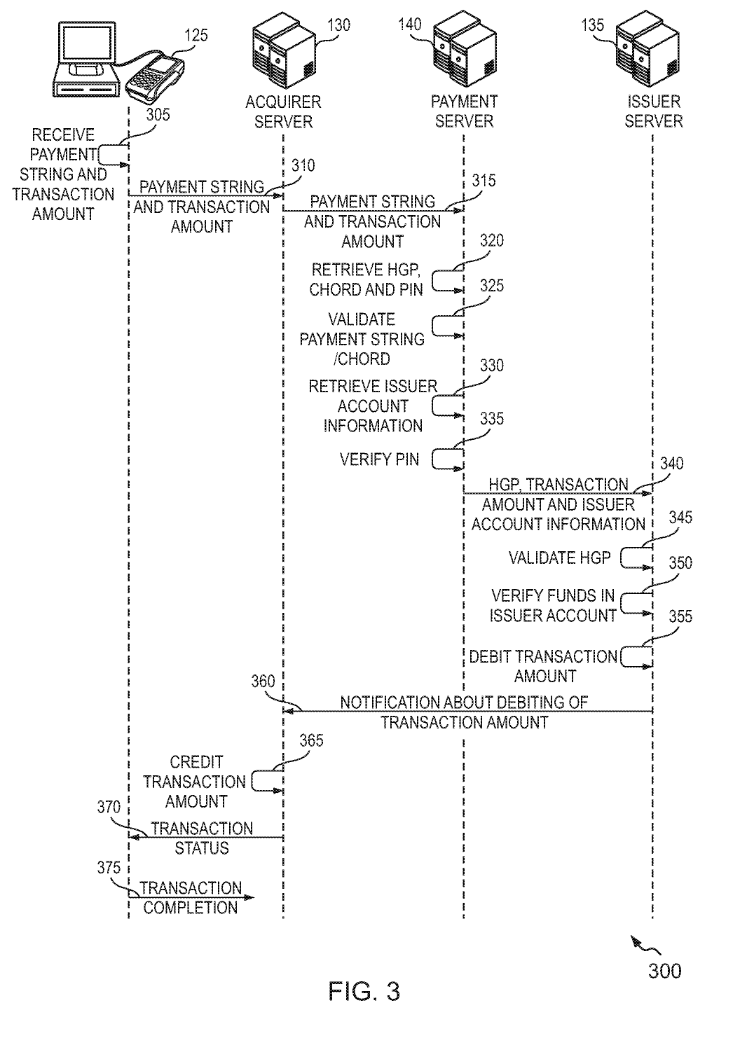

FIG. 3 represents a sequence flow diagram 300 representing a completion of a payment transaction using a payment string (e.g., the payment string 225 or 125a) at a POS terminal 125, in accordance with an example embodiment.

As a user (e.g., the user 115) purchases a product from a merchant (e.g., the merchant 110) and reaches the POS terminal for making the payment transaction, the POS terminal prompts a user interface (UI) asking the user to enter unique payment string for making the payment transaction.

At 305, the user enters a payment string using a POS terminal (e.g., the POS terminal 125). The user or the merchant (e.g., the merchant 110) can enter a transaction amount (e.g., $50) to be paid by the user for performing the financial transaction using the POS terminal 125. The transaction amount may be determined by scanning products that are bought at the facility 105. Alternatively, the mobile phone of the user may be equipped with some suitable applications to scan the bar code or price tag so as to be able to decide upon the transaction amount. In an example, the POS terminal may have a POS ID and is associated with an acquirer account of the merchant. In some alternate embodiments, the user may use an online merchant interface such as a merchant website or a third party website offering merchant's products or services. In these embodiments, the user may be asked to enter the unique payment string in a form field provided in the online merchant interface to initiate the payment transaction.

At 310, the payment string and the transaction amount i.e., the payment transaction request is sent from the merchant facility to the acquirer server 130 for further processing. As described with reference to FIG. 2, the string can have three parts i.e., HGP 205, the chord 210 and the PIN 215. Without departing from the scope of present disclosure, the string may include only two parts such as the HGP and the chord, or the chord 210 and the PIN 215 and still the payment transaction can be facilitated.

At 315, the acquirer server 130 sends the payment transaction request to the payment server 140 for verification of the payment string. The acquirer server 130 also determines the acquirer account of the merchant and sends the acquirer account details to the payment server 140.

At 320, the payment server parses the payment string to retrieve the HGP, the chord, and the PIN parts from the payment string. One or more dedicated algorithms may be utilized by the payment server 140 to retrieve the chord from the payment string, as described further with reference to FIG. 5.

At 325, the payment string is validated by the payment server 140, based on at least one rule set. Examples of the rule set may include a format of the payment string, an order of parts of the payment string, and overall length of the payment string, or length of individual parts of the payment string. In an embodiment, the payment server 140 only validates the chord part of the payment string based on the rule sets. For instance, the chord is validated based on rule sets such as predefined formats set for the chord. In an example, length (i.e., number of characters) and format (such as allowable characters used for the chord) of the chord is checked by the payment server 140. In some embodiments the operation 320 may be performed after the step 325.

The payment server 140 includes a mapping table stored in its database. The mapping table includes one or more lookup tables configured to provide required information. One example representation of the mapping table is shown in FIG. 5, where the mapping table includes a lookup table 1, which is used by the payment server 140 to retrieve hashed value associated with the chord. The hashed values are generated by hash algorithms stored in the payment server 140.

At 330, upon successful validation of the chord, the payment server 140 is configured to re-parse the chord to retrieve the user account information associated with the user. For example, the payment server 140 may utilize a lookup table-2 of the mapping table that includes the hashed values associated with the chord and corresponding issuer account information of the user. Some non-exhaustive examples of the issuer account information include bank identifier code (BIC), account number, payment card number and the like.

At 335, the payment server 140 verifies the PIN part of the payment string. as explained earlier, the PIN is issued by the issuer bank of the user for authentication the payment transactions. If the user has entered an incorrect PIN, the transaction may fail and the user and the merchant may be notified for the same. The user may also be requested to re-enter the payment string at the POS terminal 125. Similarly, if the chord part of the string is not validated, the user may be requested to re-enter the string to process the payment transaction further.

At 340, the payment server sends the retrieved HGP, the transaction amount and the retrieved issuer account information to the issuer server 135. At 345, the issuer server 135 validates the HGP of the user from an HGP database stored therein. The HGP can be generated and modified from time to time using various communication channels of the issuer such as using net banking, by physically visiting the bank, by calling the customer care of the bank or using an ATM. This is explained later in detail with reference to FIG. 6.

At 350, the issuer server 135 verifies the balance/funds in the payment account of the user (i.e., issuer account) against the received transaction amount. Upon verifying enough funds present in the issuer account, the issuer server 135 may debit the transaction amount from the issuer account of the user. (see, 355).

At 360, the issuer server 135 notifies the acquirer server 130 about the debiting of the transaction amount from the issuer account. More specifically, using the payment network 145 (i.e., the payment server 140), the issuer server 135 communicates with the acquirer server 130 after determining at operation 350, whether the user's account is in good standing and whether the purchase is covered by the user's available credit line or account balance. Based on these determinations, the available credit line or available balance of the user's account is decreased at operation 355 and thereafter the acquirer server 130 is notified about the debiting.

At 365, the acquirer server 130 credits the transaction amount in the merchant account. Thereafter, the acquirer server 130 sends the transaction status to the POS terminal 125 or to the online merchant interface (in case of user using online payment to the merchant) at 370. The transaction status may include successful, failure or pending. For example, If the HGP is not validated at operation 345, the issuer server 135 may notify the payment server 140 and thereby to the acquirer server 130 of the same. The acquirer server 130 may notify the failed transaction status to the POS terminal 125 for display to the user. The merchant may request the user to re-enter the payment string as a reattempt to process the payment transaction using the payment string. The payment transaction completes at operation 375. In this manner, the primary benefits of the present disclosure are to achieve a deep fall in frauds related to payment card based payment transactions, security against theft and simplicity using cashless and card-less transactions.

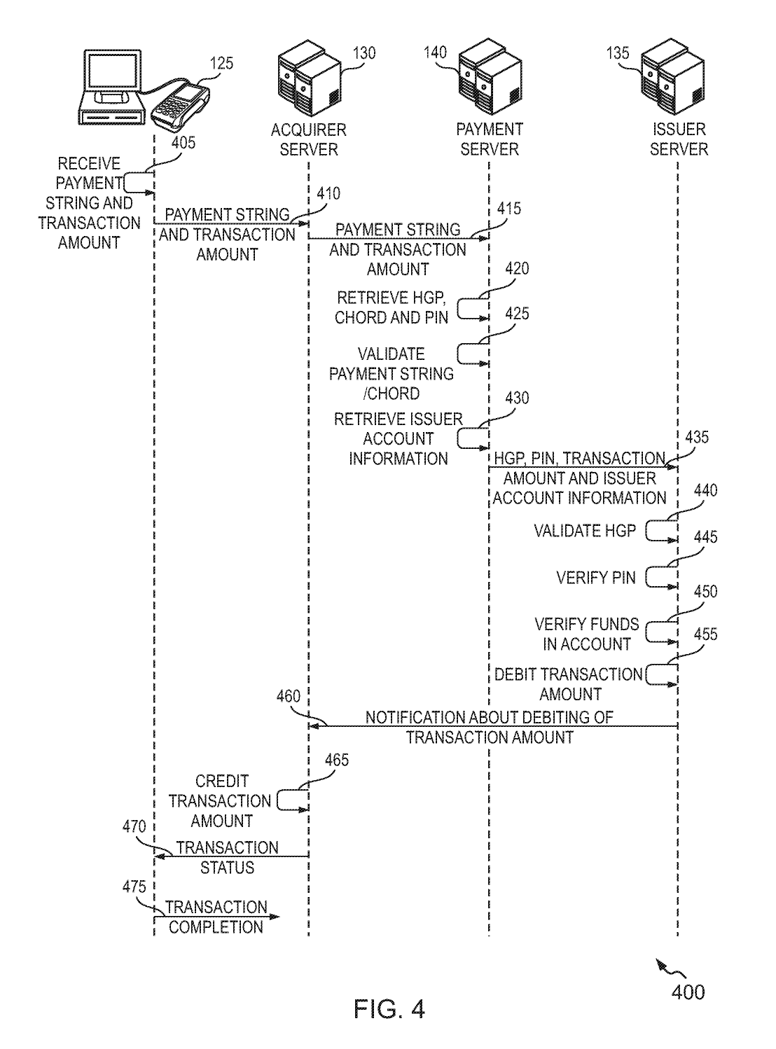

FIG. 4 represents a sequence flow diagram 400 representing a completion of a payment transaction using a payment string 225/a payment string 125a at a POS terminal 125, in accordance with another example embodiment. At 405, the POS terminal 125 receives the payment string from the user and the transaction amount from the user or the merchant. At 410, the payment transaction request is sent to the acquirer server 130. At 415, the payment transaction request is received by the payment server 140 from the acquirer server 130. The payment server 140 is configured to verify and validate the payment string received from the acquirer server 130. At 420, the payment server 140 parses the string to retrieve its parts such as the HGP, the chord and the PIN. The retrieved chord is validated by the payment server 140 using the at least one rule set such as 404 pay chord standard. At 430, upon successful validation of the chord, the payment server 140 retrieves associated issuer account information from the mapping table accessible to the payment server 140.

The retrieved issuer account information, the PIN, the HGP and the transaction amount are sent to the issuer server 135 at operation 435. At 440, the issuer server 135 is configured to validate the HGP part of the string associated with the user from a corresponding HGP database. At 445, the issuer server verifies the PIN part of the string. Upon successful verification of the PIN, at 445, the issuer server 135 verifies whether the user's payment account (i.e., the issuer account) is in good standing and whether the prospective purchase is covered by the user's available credit line or account balance. If the account holds enough balance amount, the issuer server 135 debits the exact number of transaction amount from the account at operation 455. At 460, the issuer server 135 notifies the acquirer server 130 about the debiting of the transaction amount from the issuer account using the payment network 145. At 465, the acquirer server 130 credits the debited transaction amount to the merchant account. At 470, the acquirer server 130 notifies the POS terminal 125 (or message is displayed on the online merchant interface) and thereby the merchant and the user of the transaction status. At 475, the payment transaction completes.

FIG. 5 represents a simplified schematic representation 500 including payment strings and a mapping table stored in the payment server 140 for verifying payment strings for completion of payment transactions, in accordance with an example embodiment. The representation 500 includes some examples of the payment strings (see, 505), which is parsed to retrieve the corresponding chord value. The mapping table can be represented by a combination of two tables such as a lookup table-1 (see, 550a) and a lookup table-2 (see, 550b). The columns of the table 550a represent titles a chord 510, a key to re-hash value 515 and a hashed value 520. The rows of the table 550a represent corresponding information associated with the columns. For example, row 560a represents a chord ‘2151AZ’, key to re-hash value ‘Key 1’ and a hashed value ‘xxxx1’. The table 550a includes details of a plurality of chords (predefined length alphanumeric codes) and associated hashed values. For instance, each row (e.g., the row 560a, the row 560b, through the row 560n) represents a chord, a key to re-hash value and a hashed value for the chord.

As explained with reference to operation 350 of the flow diagram 300 of FIG. 3, the payment server 140 is configured to parse the payment string to retrieve unique parts of the string. For example, the payment server 140 is configured to retrieve chord ‘3551AZ’ from the payment string ‘0213351AZ1111’, and the retrieved chord is matched with the chords 510 stored in the table 550a. Each chord is assigned a key such as ‘Key 2’ and a corresponding hashed value is generated such as ‘3456vu’ as represented by the row 560b. In one embodiment, the key is used to re-hash the hashed value for retrieving corresponding issuer account information from the lookup table-2 (see, 550b). For example, the hashed value ‘3456vu’ is re-parsed by the payment server 140 using one or more hashing algorithms to further retrieve the issuer account information.

The lookup table-2 (see, 550b) includes columns with titles a hashed value 520, a bank identifier code (BIC) 525 and account/card number 530. The table 550b includes details of a plurality of issuer account information associated with a plurality of users. For instance, each row such as the rows 580a, 580b through 580n represent corresponding issuer account information associated with the hashed value. For example, row 580b represents hashed value ‘3456vu’, corresponding BIC ‘AAAAA125’ and corresponding account number ‘5178987325’. As explained with reference to operation 340 of the flow diagram 300 of FIG. 3, the account number ‘5178987325’ and BIC ‘AAAAA125’ (i.e., the issuer account information) retrieved from the chord ‘3551AZ’ (retrieved from the payment string ‘0213351AZ1111’), is sent to the issuer server 135 for processing the payment transaction. The issuer server 135 identifies the issuer bank using BIC ‘AAAAA125’ and verifies the funds in the issuer account of the user using the account number ‘5178987325’, as explained with reference to operation 350 of the flow diagram 300 of FIG. 3.

FIG. 6 represents a simplified block diagram representation 600 of generation of a Human Generated Password (HGP) by a user, in accordance with an example embodiment. More specifically, the representation 600 depicts two aspects related to HGP, one for a new user enrollment for a user 605 and another for update/change in the HGP for an existing user 610. An issuer server 135 is shown to include (or has access of) a database such as the HGP database 615 to maintain the HGP records. The issuer server 135 can be reached by the users 605, 610 via one or more communication channels such as an ATM 625, a physical bank visit (see, 630), an internet banking 635 and a helpline call service 640. The users 605, 610 can utilize any of the communication channels to generate a new HGP or update the existing HGP, respectively. For example, the user 605 can physically visit the bank premises for registering a new HGP for utilizing the payment string based payment transactions. As another example, the user 610 can modify the HGP using internet banking applications or websites provided linked to the issuer server 135 on his/her personal electronic device. As yet another example, the users 605, 610 can update/generate the HGP using the ATM 625 or by utilizing the helpline call service 640.

In one embodiment, the HGP database 615 stores each HGP associated with each enrolled user. Further, the HGP database 615 updates the modified HGPs in real time or periodically as required. The HGP is a runtime generated dynamic password. The user may be enabled to generate HGP based on predefined patterns. For example, the user may set the HGP based on days of a week i.e., 001, 002, 003, 004, 005, 006 and 007. Alternatively, the user can set/modify the HGP based on days of month i.e., 001 . . . 030, 031. Yet alternatively, the user may define a pattern of combination of days of month and week i.e., 101, 002, 012 etc. The user may be enabled to change the HGP daily or even multiple times a day. In an example embodiment, the user may be requested to select a type of question provided by the issuer server 135 and depending on the complexity of the question, the issuer may generate an HGP with matching level of complexity for the user to use while making payment using payment string. In an example, if the user has selected the HGP as per the day of the week, the user will enter “001” as part of the payment string, when making a payment transaction on any Monday. Similarly, the user will enter “002” as part of the payment string, when making a payment transaction on any Tuesday, and so on.

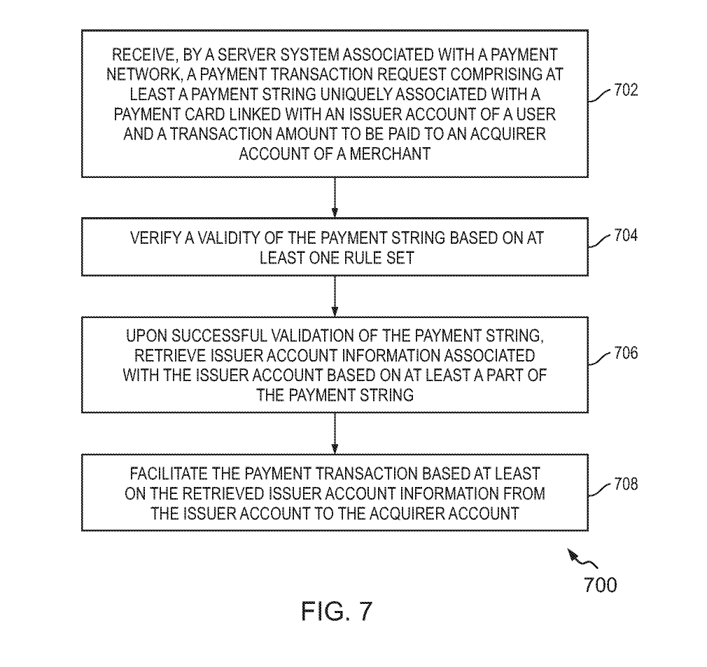

FIG. 7 illustrates a flow diagram of a method 700 for carrying out payment transaction using payment string, in accordance with an example embodiment. More specifically, a method 700 for facilitating a payment transaction from an issuer account of a user to an acquirer account of a merchant without swiping or entering card details of a payment card at a merchant interface of the merchant is disclosed. The method 700 depicted in the flow diagram may be executed by, for example, the at least one server system such as the acquirer server 130, the issuer server 135 and the payment server 140 explained with reference to FIG. 1. Operations of the flow diagram 700, and combinations of operation in the flow diagram 700, may be implemented by, for example, hardware, firmware, a processor, circuitry and/or a different device associated with the execution of software that includes one or more computer program instructions. The operations of the method 700 are described herein with help of the server systems 130, 135 or 140. It is noted that the operations of the method 700 can be described and/or practiced by using a system other than these server systems. The method 700 starts at operation 702.

At 702, the method 700 includes receiving, by a server system (e.g., the acquirer server 130) associated with a payment network, a payment transaction request. The payment transaction request includes at least a payment string (e.g., the payment string 125a) uniquely associated with the payment card linked with the issuer account and a transaction amount to be paid to the merchant.

At 704, the method 700 includes, verifying a validity of the payment string based on at least one rule set. For example, the payment server 140 may be configured to verify the validity of the payment string by checking format of the payment string received as part of the payment transaction request.

At 706, the method 700 includes retrieving issuer account information associated with the issuer account based on at least a part of the payment string upon successful validation of the payment string. In one embodiment, the issuer account information may be retrieved by matching a predefined length alphanumeric code (chord 510) in a mapping table from a database. The predefined length alphanumeric code is a part of the payment string.

At 708, the method 700 includes facilitating the payment transaction based at least on the retrieved issuer account information from the issuer account to the acquirer account. It should be appreciated that the operations 702-708 are performed without the need of the user to carry his payment cards, cash, the mobile phone or the payment card details at the merchant facility. Since the user is only required to enter the unique string, and the server systems are required to validate only a part of the payment string separately and in parallel, the overall time to complete the payment transaction reduces adequately. Such arrangement further leads to more secure payment transactions and better user experience to the user, as he/she is given the flexibility of not remembering to carry his wallet all the time.

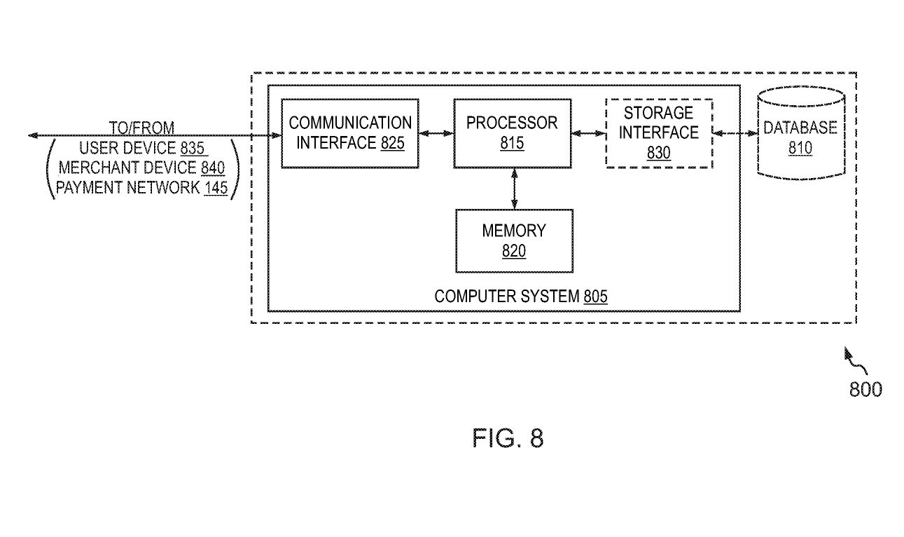

FIG. 8 is a simplified block diagram of a server system 800 used for payment transaction using payment string, in accordance with one embodiment of the present disclosure. The server system 800 is an example of a server system that is a part of the payment network 145. Examples of the server system 800 includes, but not limited to, the acquirer server 130, the issuer server 135 and the payment server 140. The server system 800 includes a computer system 805 and a database 810.

The computer system 805 includes at least one processor 815 for executing instructions. Instructions may be stored in, for example, but not limited to, a memory 820. The processor 815 may include one or more processing units (e.g., in a multi-core configuration).

The processor 815 is operatively coupled to a communication interface 825 such that computer system 805 is capable of communicating with a remote device such as a merchant device 840 (e.g., the POS terminal 125) or a user device 835 or communicating with any entity within the payment network 145. For example, the communication interface 825 may receive the payment transaction request such as the payment string uniquely associated with a user and a transaction amount from a merchant device 840, via the Internet.

The processor 815 may also be operatively coupled to the database 810. The database 810 is any computer-operated hardware suitable for storing and/or retrieving data, such as, but not limited to, transaction data generated as part of sales activities conducted over the bankcard network including data relating to merchants, account holders or customers, and purchases. The database 810 may also store information related to a plurality of user's payment accounts. Each user account data includes at least one of a user name, a user address, an account number, PIN, HGP, and other account identifiers. The database 810 may also store merchant data including a merchant identifier that identifies each merchant registered to use the payment network, and instructions for settling transactions including merchant bank account information (e.g., a plurality of payment accounts related to POS terminals associated with merchants). The database 810 may further include a mapping table composed of one or more lookup tables which include payment strings and associated issuer account information. The database 810 may include multiple storage units such as hard disks and/or solid-state disks in a redundant array of inexpensive disks (RAID) configuration. The database 810 may include a storage area network (SAN) and/or a network attached storage (NAS) system.

In some embodiments, the database 810 is integrated within computer system 805. For example, computer system 805 may include one or more hard disk drives as database 810. In other embodiments, database 810 is external to computer system 805 and may be accessed by the computer system 805 using a storage interface 830. The storage interface 830 is any component capable of providing the processor 815 with access to the database 810. The storage interface 830 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 815 with access to the database 810.

The processor 815 is configured to perform verification of the payment string and the transaction amount by communicating with the database 810. For instance, the processor 815 is configured to facilitate the authentication by validating the chord part of the payment string from corresponding information stored in the database 810. For example, the processor 815 can verify the payment card number, account number, PIN, HGP etc. by accessing respective information from the database 810. The processor 815 is further configured to approve the transaction amount by verifying against the available balance in the issuer account of the user, as stored in the database 810. Thereafter, the processor 815 is configured to complete the payment transaction of the transaction amount from issuer account to the acquirer account. The processor 815 is configured to notify the user device 835 and merchant device 840 of the transaction status via the communication interface 825.

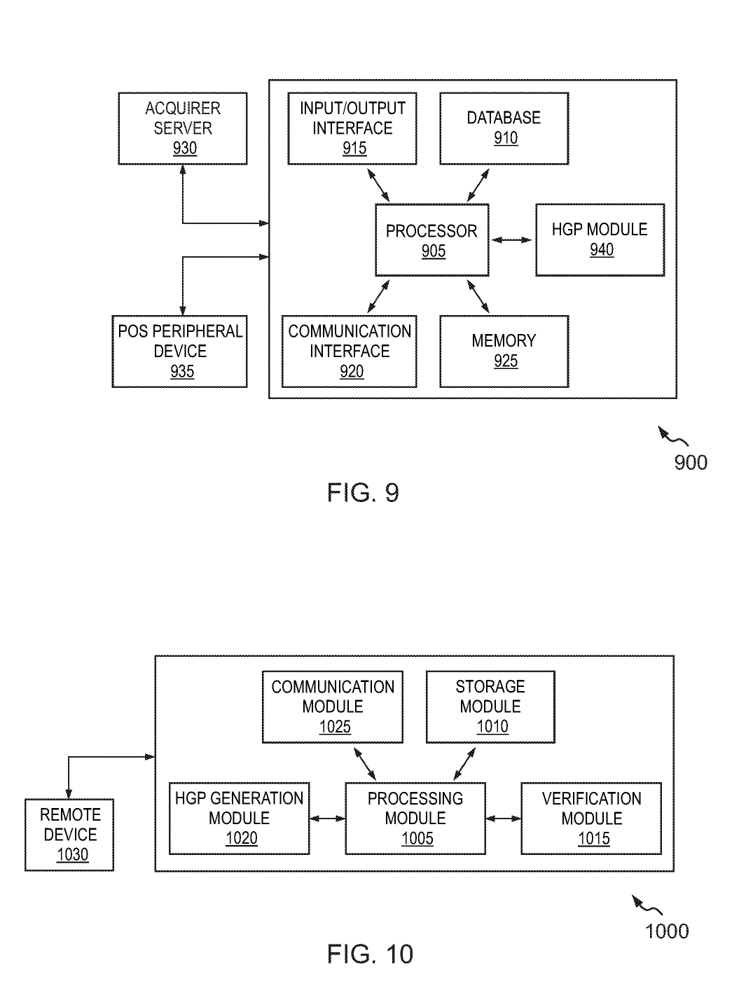

FIG. 9 is a simplified block diagram of a POS terminal 900 used for payment transaction using payment string, in accordance with one embodiment of the present disclosure. The POS terminal 900 as explained herein is only one example of the merchant device 840. In various embodiments, the merchant device 840 can be a merchant mobile phone, a kiosk, a PDA, a merchant facilitated e-commerce website interface running on a computing device and the like. The POS terminal 900 is an example of the POS terminal 125 of FIG. 1 in terms of functionalities and features. The POS terminal 900 includes at least one processor 905 communicably coupled to a database 910, an Input/Output (I/O) interface 915, a communication interface 920, a memory 925 and an HGP module 940. The components of the POS terminal 900 provided herein may not be exhaustive, and that the POS terminal 900 may include more or fewer components than that of depicted in FIG. 9. Further, two or more components may be embodied in one single component, and/or one component may be configured using multiple sub-components to achieve the desired functionalities. Some components of the POS terminal 900 may be configured using hardware elements, software elements, firmware elements and/or a combination thereof.

The I/O interface 915 is configured to receive inputs from and provide outputs to the end-user (i.e., the merchant and/or the customer) of the POS terminal 900. For instance, the I/O module 915 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 925 can be any type of storage accessible to the processor 905. For example, the memory 925 may include volatile or non-volatile memories, or a combination thereof. In some non-limiting examples, the memory 925 can be four to sixty four MegaBytes (MB) of Dynamic Random Access Memory (“DRAM”) or Static Random Access Memory (“SRAM”). In addition, some examples may include supplementary flash memory installed via a PCMCIA slot.

The database 910 is capable of storing and/or retrieving data, such as, but not limited to, smart card insertions, user/customer information, merchant information, payment strings uniquely associated with each user, card swipes, touch-screen key depressions, keypad key depressions, number of dots printed by the slip and roll printers, check read errors, and the like. Such information can be accessed by the processor 905 using the communication interface 920 to determine potential future failures and the like.

The POS terminal 900 is capable of communicating with one or more POS peripheral devices such as the POS peripheral deice 935 and external server system such as an acquirer server 930 (an example of the acquirer server 130 of FIG. 1) via the communication interface 920 over a communication network such as the network 150 of FIG. 1. The POS peripheral device 935 can provide functionality, which is used by a consumer at a merchant facility, such as PIN entry, payment string entry, clear text entry, signature capture, and the like. Some non-exhaustive examples of the peripheral device 935 include barcode scanner, cash drawer, magnetic stripe reader, receipt printer, PIN pad, signature capture device, touchscreen, keyboard, portable data terminal, card reader, customer pole display and the like. In some embodiments, the POS terminal 900 may be mounted near a cash register at a check-out counter in merchant facility, while the POS peripheral device 935 may be mounted on the check-out counter such that it is accessible to the users. In this way, both the merchant and the user/customer can interact with similar devices to process the payment transaction.

The communication interface 920 is further configured to cause display of user interfaces on the POS terminal 900. For example, using a corresponding UI, the communication interface 920 may display a new payment option such as the payment using based payment transaction. The user may select the option displayed on the POS terminal 900 to initiate the payment transaction using the payment string. In one embodiment, the communication interface 220 includes a transceiver for wirelessly communicating information to, or receiving information from, the acquirer server 930 or other suitable display device, and/or another type of remote processing device. In another embodiment, the communication interface 920 is capable of facilitating operative communication with the remote devices and a cloud server using Application Program Interface (API) calls. The communication may be achieved over a communication network, such as the network 150.

The processor 905 is capable of sending the payment transaction request received from the end-user via the communication interface 920 to the acquirer server 930 for processing the payment transaction. For example, the processor 905 is configured to receive the payment string and the transaction amount entered by the end-user using the Uls. The processor 905 can access the database 925 to retrieve the user information and merchant information that are required to be sent along with the payment transaction request to the acquirer server 930.

Additionally, the POS terminal 900 can include an operating system and various software applications that can provide various functionality to the POS terminal 900. For example, in some embodiments, the POS terminal 900 is addressable with an Internet protocol and includes a browser application. In such embodiments, the processor 905 includes software adapted to support such functionality. In some embodiments, the processor 905 executes software to support network management. In particular, this capacity allows software to be downloaded to a plurality of such systems to provide new applications such as applications for enabling payment string based payment transactions using POS terminals and/or updates to existing applications. The operating system and software application upgrades are distributed and maintained through communication to the POS terminal 900 over the communication network 150. For example, existing POS terminals may be adapted to download a new HGP module such as the HGP module 940 of the POS terminal 900 that supports new functionalities for enabling payment string based payment transactions. Using the program instructions stored in the HGP module 940, the processor 905, may be configured to facilitate the end user to pay using the payment string, where the entered payment string is communicated to the acquirer server 1100.

FIG. 10 is a simplified block diagram of an issuer server 1000 for payment transaction using payment string, in accordance with one embodiment of the present disclosure. The issuer server 1000 is an example of the issuer server 135 of FIG. 1, or may be embodied in the issuer server 135. The issuer server 1000 is associated with an issuer bank/issuer, in which a user may have an account, which provides a payment string based electronic payment transaction facility. The issuer server 1000 includes a processing module 1005 operatively coupled to a storage module 1010, a verification module 1015, an HGP generation module 1020, and a communication module 1025. The components of the issuer server 1000 provided herein may not be exhaustive, and that the issuer server 1000 may include more or fewer components than that of depicted in FIG. 10. Further, two or more components may be embodied in one single component, and/or one component may be configured using multiple sub-components to achieve the desired functionalities. Some components of the issuer server 1000 may be configured using hardware elements, software elements, firmware elements and/or a combination thereof.

The storage module 1010 is configured to store machine executable instructions to be accessed by the processing module 1005. Additionally, the storage module 1010 stores information related to, contact information of the user, bank account number, BICs, payment card details, HGP and any updates in the HGP (such as stored in the HGP database 615 of FIG. 6), internet banking information, PIN, mobile personal identification number (MPIN) for mobile banking and the like. This information is retrieved by the processing module 1005 for cross-verification during payment transactions.

The HGP generation module 1020 is configured to facilitate a user to register/enroll for payment string based payment transactions by generating an HGP. The HGP generation module 1020 includes logics to pre-define one or more patterns based on which the user can generate/update the HGP from time to time as explained with reference FIG. 6 earlier. The HGPs generated by the HGP generation module 1020 are stored in the storage module 1010 for later retrieval by the processing module 1005 for verification purposes.

The processing module 1005, in conjunction with the verification module 1015, is configured to verify the HGP (e.g., whether the three-digit password is set as per the predefined pattern), the PIN (e.g., whether the four-digit numeric code matches the PIN issued by the issuer), the sufficient funds in the issuer account, payment card details and the like. Upon successful verification only, the payment transaction is processed further by the processing module 1005 by debiting the transaction amount from the issuer account of the user. The processing module 1005 is further configured to communicate with one or more remote devices such as the remote device 1030 using the communication module 1025 over a network such as the network 150 or the payment network 145 of FIG. 1. The examples of the remote device 1030 include, the merchant device 840, the user device 835, the payment server 140, the acquirer server 130, other computing systems of issuer and payment network 145 and the like. The communication module 1025 is capable of facilitating such operative communication with the remote devices and cloud servers using API (Application Program Interface) calls.

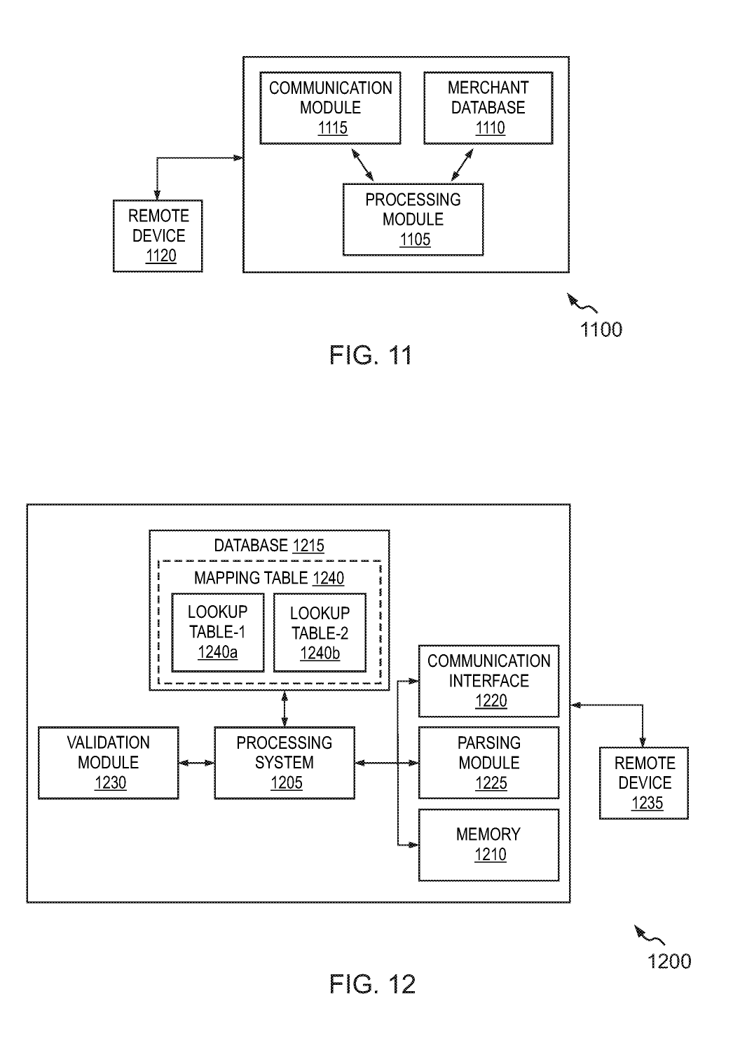

FIG. 11 is a simplified block diagram of an acquirer server 1100 used for payment transaction using payment string, in accordance with one embodiment of the present disclosure. The acquirer server 1100 is associated with the acquirer bank of a merchant where the merchant has established an account to accept payment using the payment string. The acquirer server 1100 is an example of the acquirer server 130 of FIG. 1, or may be embodied in the acquirer server 130. Further, the acquirer server 1100 is configured to facilitate payment string based payment transaction with the issuer server 1000 using the payment network 145 of FIG. 1. The acquirer server 1100 includes a processing module 1105 communicably coupled to a merchant database 1110 and a communication module 1115. The components of the acquirer server 1100 provided herein may not be exhaustive, and the acquirer server 1100 may include more or fewer components than that of depicted in FIG. 11. Further, two or more components may be embodied in one single component, and/or one component may be configured using multiple sub-components to achieve the desired functionalities. Some components of the acquirer server 1100 may be configured using hardware elements, software elements, firmware elements and/or a combination thereof.

The merchant database 1110 includes data related to merchant, such as, but not limited to, a merchant primary account number (PAN), a merchant name, a merchant category code (MCC), a merchant city, a merchant postal code, a merchant brand name, a merchant ID and the like. The processing module 1105 is configured to use the merchant ID to identify the merchant during the normal processing of payment transactions, adjustments, chargebacks, end-of-month fees and so forth. The merchant ID is different than other merchant account numbers, particularly those that identify merchants to the equipment (e.g., the POS terminals or any other merchant electronic devices) they use for processing transactions. A merchant with a single merchant processing account number may use several terminals at one location, resulting in one merchant ID and several terminal identification numbers (TIDs). The processing module 1105 may be configured to store and update such merchant information in the merchant database 1110 for later retrieval.

In an embodiment, the communication module 1115 is capable of facilitating operative communication with the remote device 1120 (e.g., the POS terminal 900, the issuer server 1000, the merchant device 840 and/or the payment server 140) using API calls. The communication may be achieved over a communication network, such as the network 150. For example, the processing module 1105 may receive the payment string and the transaction amount from the POS terminal 900 using the communication module 1115. Further, the processing module 1105 is configured to receive the debited transaction amount from the payment server 140 or the issuer server 135 (or the issuer server 1000) using the communication module 1115. Thereafter, the processing module 1105 may retrieve merchant PAN from the database 1110 to credit the transaction amount in the acquirer account of the merchant. Further, the processing module 1105 may be configured to send the transaction status to the POS terminal 900 of the merchant.

FIG. 12 is a simplified block diagram of a payment server 1200 used for payment transaction using payment string, in accordance with one embodiment of the present disclosure. The payment server 1200 may correspond to the payment server 140 of FIG. 1. As explained with reference to FIG. 1, the payment server 140 is associated with a payment network 145. The payment network 145 may be used by issuer server 1000 and acquirer server 1100 as a payment interchange network. Examples of payment interchange network include, but not limited to, Mastercard® payment system interchange network. The payment server 1200 includes a processing system 1205 configured to extract programming instructions from a memory 1210 to provide various features of the present disclosure. The components of the payment server 1200 provided herein may not be exhaustive, and that the payment server 1200 may include more or fewer components than that of depicted in FIG. 12. Further, two or more components may be embodied in one single component, and/or one component may be configured using multiple sub-components to achieve the desired functionalities. Some components of the payment server 1200 may be configured using hardware elements, software elements, firmware elements and/or a combination thereof.

Via a communication interface 1220, the processing system 1205 receives a payment string and transaction amount from a remote device 1235 such as the POS terminal 900 or the acquirer server 1100. The communication may be achieved through API calls, without loss of generality. A parsing module 1225 is operatively coupled to the processing system 1205. The parsing module 1225 includes one or more parsing algorithms capable of parsing the payment string and thereby extracting the chord. The chord retrieved from the payment string is validated by the processing system 1205 using a validation module 1230 that includes a predefined rule set to be used for validation purposes. Without loss of generality, a mapping table 1240 stored in a database 1215 includes a lookup table-1 (see, 1240a) and a lookup table-2 (see, 1240b) to be utilized by the processing system 1205 to retrieve issuer account information. As explained with reference to FIG. 5, the processing system 1205 is configured to include one or more hashing algorithms to re-parse the chord to generate hashed values. The hashed values are stored in the mapping table 1240 and are associated with issuer account information of each user. Apart from the mapping table 1240, the database 1215 stores the PIN, the HGP, the transaction amount, acquirer account information, transaction records, merchant account information, and the like. Upon successful validation of the PIN and the chord, the processing system 1205 sends the HGP to the issuer server 1000 for verification and completion of the payment transaction via the communication interface 1220.

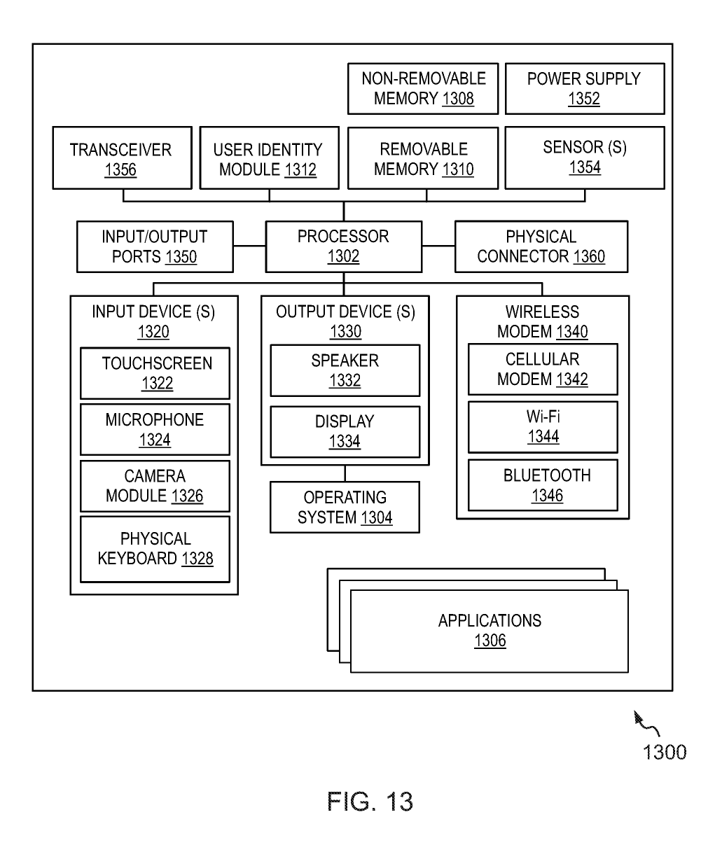

FIG. 13 shows simplified block diagram of a user device 1300 for example a mobile phone or a desktop computer capable of implementing the various embodiments of the present disclosure. For example, the user device 1300 may correspond to the user device 835 of FIG. 8. The user device 1300 is depicted to include one or more applications 1306.

It should be understood that the user device 1300 as illustrated and hereinafter described is merely illustrative of one type of device and should not be taken to limit the scope of the embodiments. As such, it should be appreciated that at least some of the components described below in connection with that the user device 1300 may be optional and thus in an example embodiment may include more, less or different components than those described in connection with the example embodiment of the FIG. 13. As such, among other examples, the user device 1300 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1300 includes a controller or a processor 1302 (e.g., a signal processor, microprocessor, ASIC, or other control and processing logic circuitry) for performing such tasks as signal coding, data processing, image processing, input/output processing, power control, and/or other functions. An operating system 1304 controls the allocation and usage of the components of the user device 1300 and support for one or more payment transaction applications programs (see, applications 1306), that implements one or more of the innovative features described herein. In addition, the applications 1306 may include common mobile computing applications (e.g., telephony applications, email applications, calendars, contact managers, web browsers, messaging applications) or any other computing application.

The illustrated user device 1300 includes one or more memory components, for example, a non-removable memory 1308 and/or removable memory 1310. The non-removable memory 1308 and/or removable memory 1310 may be collectively known as database in an embodiment. The non-removable memory 1308 can include RAM, ROM, flash memory, a hard disk, or other well-known memory storage technologies. The removable memory 1310 can include flash memory, smart cards, or a Subscriber Identity Module (SIM). The one or more memory components can be used for storing data and/or code for running the operating system 1304 and the applications 1306. The user device 1300 may further include a user identity module (UIM) 1312. The UIM 1312 may be a memory device having a processor built in. The UIM 1312 may include, for example, a subscriber identity module (SIM), a universal integrated circuit card (UICC), a universal subscriber identity module (USIM), a removable user identity module (R-UIM), or any other smart card. The UIM 1312 typically stores information elements related to a mobile subscriber. The UIM 1312 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1300 can support one or more input devices 1320 and one or more output devices 1330. Examples of the input devices 1320 may include, but are not limited to, a touch screen/a display screen 1322 (e.g., capable of capturing finger tap inputs, finger gesture inputs, multi-finger tap inputs, multi-finger gesture inputs, or keystroke inputs from a virtual keyboard or keypad), a microphone 1324 (e.g., capable of capturing voice input), a camera module 1326 (e.g., capable of capturing still picture images and/or video images) and a physical keyboard 1328. Examples of the output devices 1330 may include, but are not limited to a speaker 1332 and a display 1334. Other possible output devices can include piezoelectric or other haptic output devices. Some devices can serve more than one input/output function. For example, the touch screen 1322 and the display 1334 can be combined into a single input/output device.

A wireless modem 1340 can be coupled to one or more antennas (not shown in the FIG. 13) and can support two-way communications between the processor 1302 and external devices, as is well understood in the art. The wireless modem 1340 is shown generically and can include, for example, a cellular modem 1342 for communicating at long range with the mobile communication network, a Wi-Fi compatible modem 1344 for communicating at short range with an external Bluetooth-equipped device or a local wireless data network or router, and/or a Bluetooth-compatible modem 1346. The wireless modem 1340 is typically configured for communication with one or more cellular networks, such as a GSM network for data and voice communications within a single cellular network, between cellular networks, or between the user device 1300 and a public switched telephone network (PSTN).

The user device 1300 can further include one or more input/output ports 1350, a power supply 1352, one or more sensors 1354 for example, an accelerometer, a gyroscope, a compass, or an infrared proximity sensor for detecting the orientation or motion of the user device 1300 and biometric sensors for scanning biometric identity of an authorized user, a transceiver 1356 (for wirelessly transmitting analog or digital signals) and/or a physical connector 1360, which can be a USB port, IEEE 1294 (FireWire) port, and/or RS-232 port. The illustrated components are not required or all-inclusive, as any of the components shown can be deleted and other components can be added.

The disclosed methods with reference to FIGS. 3 and 4, or one or more operations of the flow diagram 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems 130, 135 and 140 its various components such as the computer system 805 and the database 810 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of facilitating a payment transaction from an issuer account of a user to an acquirer account of a merchant without swiping or entering card details of a payment card at a merchant interface of the merchant, the method comprising:
receiving, by a server system associated with a payment network, a payment transaction request comprising at least a payment string uniquely associated with the payment card linked with the issuer account and a transaction amount to be paid to the merchant;
verifying a validity of the payment string based on at least one rule set;
upon successful validation of the payment string, retrieving issuer account information associated with the issuer account based on at least a part of the payment string; and
facilitating the payment transaction, based at least on the retrieved issuer account information, from the issuer account to the acquirer account.

2. The method as claimed in claim 1, wherein the payment string comprises a combination of a user generated password, a predefined length alphanumeric code associated with the payment card, and a personal identification number (PIN) of the payment card.

3. The method as claimed in claim 2, wherein verifying the validity of the payment string comprises checking format of the predefined length alphanumeric code of the payment string received as part of the payment transaction request.

4. The method as claimed in claim 2, wherein the merchant interface is a point of sale (POS) terminal, and wherein receiving the payment transaction request comprises at least receiving the payment string provided as input to a user interface of the POS terminal without swiping or inserting the payment card in the POS terminal.

5. The method as claimed in claim 2, wherein the merchant interface is an online merchant interface, and wherein receiving the payment transaction request comprises at least receiving the payment string from a prompt displayed on the online merchant interface.

6. The method as claimed in claim 2, wherein retrieving the payment information comprises:
parsing the payment string to identify the predefined length alphanumeric code;
accessing a mapping table, the mapping table configured to store mapping of a plurality of predefined length alphanumeric codes and a plurality of issuer account information associated with a plurality of users; and
determining the issuer account information from among the plurality of issuer account information based on matching the predefined length alphanumeric code from among the plurality of predefined length alphanumeric codes present in the mapping table.

7. The method as claimed in claim 6, wherein the server system is a payment server of the payment network, and wherein facilitating the payment transaction further comprises:
transmitting the issuer account information associated with the issuer account, the transaction amount and acquirer account information associated with the acquirer account to an issuer server of the payment network; and
transmitting the user generated password to the issuer server, wherein the issuer server is configured to verify the user generated password for making the payment transaction.

8. The method as claimed in claim 7, wherein facilitating the payment transaction further comprises transmitting the PIN to the issuer server, wherein the issuer server is further configured to verify the PIN for making the payment transaction.

9. The method as claimed in claim 7, wherein facilitating the payment transaction further comprises verifying the PIN.

10. The method as claimed in claim 2, wherein the user generated password is a dynamic password configured to change based on a predefined pattern.

11. The method as claimed in claim 2, wherein the user generated password comprises three digits and the predefined length alphanumeric code comprises six characters.

12. A server system in a payment network, the server system configured to facilitate a payment transaction from an issuer account of a user to an acquirer account of a merchant without swiping or entering card details of a payment card at a merchant interface of the merchant, the server system comprising:
a communication interface configured to receive a payment transaction request comprising at least a payment string uniquely associated with the payment card linked with the issuer account and a transaction amount to be paid to the merchant; and
at least one processor in operative communication with the communication interface, the at least one processor configured to:
verify a validity of the payment string based on at least one rule set;
upon successful validation of the payment string, retrieve issuer account information associated with the issuer account based on at least a part of the payment string; and
facilitate the payment transaction based at least on the retrieved issuer account information from the issuer account to the acquirer account.

13. The server system as claimed in claim 12, wherein the payment string comprises a combination of a user generated password, a predefined length alphanumeric code associated with the payment card, and a personal identification number (PIN) of the payment card.

14. The server system as claimed in claim 13, wherein the at least one processor is configured to verify the validity of the payment string by checking format of the predefined length alphanumeric code of the payment string received as part of the payment transaction request.

15. The server system as claimed in claim 13, wherein the merchant interface is a point of sale (POS) terminal; and
wherein the communication interface is configured to receive the payment transaction request by at least receiving the payment string provided as input to a user interface of the POS terminal without swiping or inserting the payment card in the POS terminal.

16. The server system as claimed in claim 13, wherein the at least one processor is configured, in connection with retrieving the issuer account information, to:
parse the payment string to identify the predefined length alphanumeric code;
access a mapping table, the mapping table configured to store mapping of a plurality of predefined length alphanumeric codes and a plurality of issuer account information associated with a plurality of users; and
determine the issuer account information from among the plurality of issuer account information based on matching the predefined length alphanumeric code from among the plurality of predefined length alphanumeric codes present in the mapping table.

17. The server system as claimed in claim 16, wherein the server system is a payment server of the payment network; and
wherein the at least one processor is configured, in connection with facilitating the payment transaction, to:
transmit the issuer account information associated with the issuer account, the transaction amount and acquirer account information associated with the acquirer account to an issuer server of the payment network; and
transmit the user generated password to the issuer server, wherein the issuer server is configured to verify the user generated password for making the payment transaction.

18. The server system as claimed in claim 16, wherein the at least one processor is configured, in connection with facilitating the payment transaction, to transmit the PIN to the issuer server, wherein the issuer server is further configured to verify the PIN for making the payment transaction.

19. A server system in a payment network, the server system configured to facilitate a payment transaction from an issuer account of a user to an acquirer account of a merchant without swiping or entering card details of a payment card at a merchant interface of the merchant, the server system comprising:
a database comprising a mapping table, the mapping table configured to store mapping of a plurality of predefined length alphanumeric codes and a plurality of issuer account information associated with a plurality of users;
a communication interface configured to receive a payment transaction request comprising at least a payment string uniquely associated with the payment card linked with the issuer account and a transaction amount to be paid to the merchant, the payment string comprising a predefined length alphanumeric code of the plurality of predefined length alphanumeric codes;
a memory comprising executable instructions; and
a processor communicably coupled to the communication interface and the database, the processor configured to execute the instructions in the memory to cause to the server system to:
verify a validity of at least the predefined length alphanumeric code of the payment string based on at least one rule set;
upon successful validation of the predefined length alphanumeric code, retrieve an issuer account information associated with the issuer account based on matching the predefined length alphanumeric code in the mapping table; and
facilitate the payment transaction based at least on the retrieved issuer account information from the issuer account to the acquirer account.

20. The server system as claimed in claim 19, wherein the payment string comprises a combination of a user generated password, the predefined length alphanumeric code and a PIN of the payment card; and
wherein the server system is further caused to verify the user generated password and the PIN to complete the payment transaction.
